(19) United States
(12) Patent Application Publication
(10) Pub. No.: US 2025/0060694 A1
(43) Pub. Date: Feb. 20, 2025

(54) ROTATION APPARATUS, FIXING APPARATUS, AND IMAGE FORMING APPARATUS

(71) Applicant: FUJIFILM Business Innovation Corp., Tokyo (JP)

(72) Inventors: Takayuki UKAWA, Kanagawa (JP); Hideki KUGE, Kanagawa (JP); Yoshiki SHIMODAIRA, Kanagawa (JP); Masato YAMASHITA, Kanagawa (JP); Yutaka KIUCHI, Kanagawa (JP); Takayuki YAMASHITA, Kanagawa (JP)

(73) Assignee: FUJIFILM Business Innovation Corp., Tokyo (JP)

(21) Appl. No.: 18/444,275

(22) Filed: Feb. 16, 2024

(30) Foreign Application Priority Data
Aug. 15, 2023 (JP) 2023-132338

(51) Int. Cl. G03G 15/20

(52) U.S. Cl. CPC G03G 15/2053; G03G 15/2064; G03G 2215/2061

(57) ABSTRACT

A rotation apparatus includes a first rotating body rotatable; a second rotating body movable to a contact position at which the second rotating body contacts an outer circumferential surface of the first rotating body and a separation position at which the second rotating body is separated from the first rotating body outward in a radial direction of the first rotating body and rotatable in a reverse direction to the rotation direction; a first drive mechanism that rotationally drives the first rotating body at a first circumferential speed and rotates the second rotating body at the contact position; and a second drive mechanism that generates a driving force, rotationally drives the second rotating body at a second circumferential speed lower than the first circumferential speed at the separation position, and applies a resistance force to the first rotating body via the second rotating body at the contact position.

### CROSS-REFERENCE TO RELATED APPLICATIONS

This application is based on and claims priority under 35 USC 119 from Japanese Patent Application No. 2023-132338 filed Aug. 15, 2023.

### BACKGROUND

### (i) Technical Field

The present disclosure relates to a rotation apparatus, a fixing apparatus, and an image forming apparatus.

### (ii) Related Art

Japanese Unexamined Patent Application Publication No. 2011-184189 discloses a medium conveyance apparatus including: an impression cylinder that has a cylindrical shape, rotates about a central axis to rotatably convey a medium supported on a circumferential surface thereof, is provided with a fixing member fixing an edge portion of the medium in a conveyance direction over a length corresponding to a full width of the medium supported on the circumferential surface in a direction substantially orthogonal to the conveyance direction, and is provided with cam portions having a height exceeding a height of the fixing member and a structure protruding to the circumferential surface at respective outer sides of both ends of the fixing member in the direction substantially orthogonal to the conveyance direction; and an abutting member having a length exceeding a distance between one cam portion and the other cam portion in the direction substantially orthogonal to the conveyance direction, the abutting member being biased to abut against the medium supported on the circumferential surface of the impression cylinder and being configured to ride on the cam portions without contacting the fixing member, in which the impression cylinder includes a first magnetic field generating unit that generates a predetermined magnetic field at least at a position on the circumferential surface where the abutting member that rides on the cam portion lands, and the abutting member includes a second magnetic field generating unit that generates a magnetic field that generates a repulsive force against the magnetic field generated by the first magnetic field generating unit.

Japanese Unexamined Patent Application Publication No. 2007-183682 discloses a fixing apparatus that includes a fixing rotating body including a heat source, and a pressing rotating body disposed in pressure-contact with the fixing rotating body, and that introduces and passes a recording medium carrying a toner image to be fixed into a pressure-contact portion formed between the fixing rotating body and the pressing rotating body with a toner image carrying surface of the recording medium positioned on the fixing rotating body side. The fixing apparatus includes speed changing means for changing a setting value related to a rotational drive speed of the fixing rotating body or the pressing rotating body from a fixing speed value to a lower speed value at a time before a rear end portion of the recording medium leaves the pressure-contact portion, in which the speed changing means changes the setting value from the fixing speed value to the lower speed value at a time when a condition L≥2/D is satisfied, where D denotes a width of the pressure-contact portion in a recording medium passing direction and D denotes a distance from an outlet side end of the pressure-contact portion to the rear end portion of the recording medium.

### SUMMARY

As a rotation apparatus, a rotation apparatus is conceivable which includes a first rotating body rotatable in a predetermined rotation direction; a second rotating body movable between a contact position at which the second rotating body comes into contact with an outer circumferential surface of the first rotating body and a separation position at which the second rotating body is separated from the outer circumferential surface outward in a radial direction of the first rotating body and rotatable in a reverse direction to the rotation direction; a first drive mechanism that rotationally drives the first rotating body and subordinately rotates the second rotating body at the contact position; and a second drive mechanism that generates a driving force in the reverse direction with respect to the second rotating body at the contact position and the separation position, rotationally drives the second rotating body at the separation position, and constantly applies a rotating force in the rotation direction to the first rotating body via the second rotating body at the contact position.

In the rotation apparatus, since the second drive mechanism constantly applies the rotating force in the rotation direction to the first rotating body via the second rotating body at the contact position, when the second rotating body moves from the contact position to the separation position, a fluctuation in torque generated in the first rotating body is large.

Aspects of non-limiting embodiments of the present disclosure relate to a rotation apparatus including: a first rotating body rotatable in a predetermined rotation direction; a second rotating body movable to a contact position at which the second rotating body comes into contact with an outer circumferential surface of the first rotating body and a separation position at which the second rotating body is separated from the outer circumferential surface outward in a radial direction of the first rotating body and rotatable in a reverse direction to the rotation direction; a first drive mechanism that rotationally drives the first rotating body and subordinately rotates the second rotating body at the contact position; and a second drive mechanism that generates a driving force in the reverse direction with respect to the second rotating body at the contact position and the separation position and rotationally drives the second rotating body at the separation position, in which compared to a case where the second drive mechanism constantly applies a rotating force in the rotation direction to the first rotating body via the second rotating body at the contact position, a fluctuation in torque generated in the first rotating body is suppressed when the second rotating body moves from the contact position to the separation position.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a rotation apparatus including a first rotating body rotatable in a predetermined rotation direction; a second rotating body movable to a contact position at which the second rotating body comes into contact with an outer circumferential surface of the first rotating body and a separation position at which the second rotating body is separated from the first rotating body outward in a radial direction of the first rotating body and rotatable in a reverse direction to the rotation direction; a first drive mechanism that rotationally drives the first rotating body at a first circumferential speed and subordinately rotates the second rotating body at the contact position; and a second drive mechanism that generates a driving force in the reverse direction with respect to the second rotating body at the contact position and the separation position, rotationally drives the second rotating body at a second circumferential speed lower than the first circumferential speed at the separation position, and applies a resistance force in the reverse direction to the first rotating body via the second rotating body at the contact position.

### BRIEF DESCRIPTION OF THE DRAWINGS

An exemplary embodiment of the present disclosure will be described in detail based on the following figures, wherein:

FIG. 1 is a schematic diagram illustrating an image forming apparatus according to the present exemplary embodiment;

FIG. 2 is a perspective diagram illustrating a configuration around a transfer cylinder according to the present exemplary embodiment;

FIG. 3 is a perspective diagram illustrating a configuration around a fixing cylinder according to the present exemplary embodiment;

FIG. 4 is a perspective diagram illustrating a gripper according to the present exemplary embodiment;

FIG. 5 is a side diagram illustrating the fixing cylinder, a heating roll, a pair of external heating rolls, a first drive mechanism, and a second drive mechanism according to the present exemplary embodiment;

FIG. 6 is a side diagram illustrating a separated state between the fixing cylinder and the heating roll in the configuration illustrated in FIG. 5;

FIG. 7 is a schematic diagram illustrating the fixing cylinder, the heating roll, and the pair of external heating rolls according to the present exemplary embodiment;

FIG. 8 is a schematic diagram illustrating a separated state between the fixing cylinder and the heating roll in the configuration illustrated in FIG. 7;

FIG. 9 is a schematic diagram illustrating a state in which the fixing cylinder and the heating roll sandwich a recording medium in the configuration illustrated in FIG. 7;

FIG. 10 is a side diagram illustrating circumferential speeds of the fixing cylinder and the heating roll according to the present exemplary embodiment;

FIG. 11 is a schematic diagram illustrating a contact state between the fixing cylinder and the heating roll in the configuration illustrated in FIG. 10;

FIG. 12 is a graph illustrating torque generated in the fixing cylinder according to the present exemplary embodiment;

FIG. 13 is a side diagram illustrating an example of a case where the circumferential speed of the heating roll is higher than the circumferential speed of the fixing cylinder;

FIG. 14 is a schematic diagram illustrating a contact state between the fixing cylinder and the heating roll in the configuration illustrated in FIG. 13;

FIG. 15 is a graph illustrating torque generated in the fixing cylinder in the configuration illustrated in FIG. 13;

FIG. 16 is a side diagram illustrating an example of a case where the circumferential speed of the heating roll and the circumferential speed of the fixing cylinder are the same;

FIG. 17 is a schematic diagram illustrating a contact state between the fixing cylinder and the heating roll in the configuration illustrated in FIG. 16; and

FIG. 18 is a graph illustrating torque generated in the fixing cylinder in the configuration illustrated in FIG. 16.

### DETAILED DESCRIPTION

Hereinafter, an example of an exemplary embodiment according to the present disclosure will be described with reference to the drawings.

### Image Forming Apparatus 10

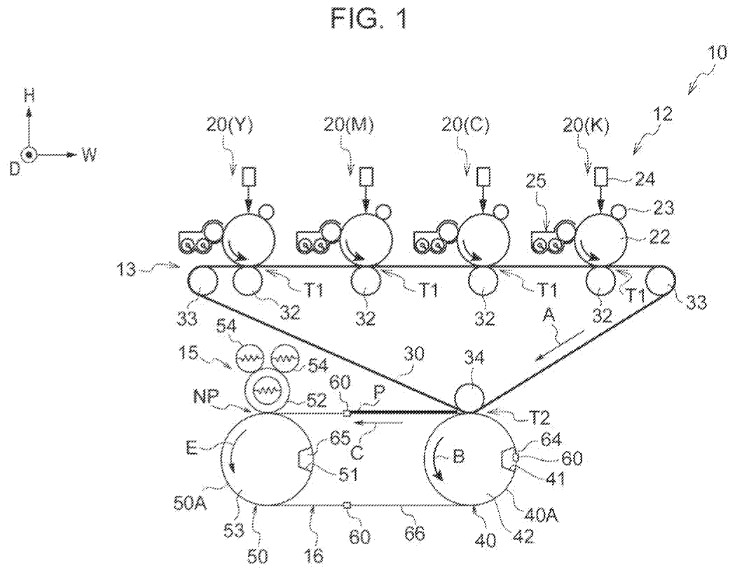

A configuration of an image forming apparatus 10 according to the present exemplary embodiment will be described. FIG. 1 is a schematic diagram illustrating a configuration of the image forming apparatus 10 according to the present exemplary embodiment. Note that in each of the drawings, an arrow H indicates a vertical direction and an apparatus up-down direction, an arrow W indicates a horizontal direction and an apparatus width direction, and an arrow D indicates a horizontal direction and an apparatus depth direction (apparatus front-rear direction). Dimensional ratios between portions illustrated in the drawings in the H direction, the W direction, and the D direction may be different from actual dimensional ratios.

The image forming apparatus 10 illustrated in FIG. 1 is an image forming apparatus that forms a toner image (an example of an image) on a recording medium P. Specifically, the image forming apparatus 10 includes an image forming unit 12, a fixing apparatus 15, and a conveyance mechanism 16. Hereinafter, each unit (the image forming unit 12, the fixing apparatus 15, and the conveyance mechanism 16) of the image forming apparatus 10 will be described.

### Image Forming Unit 12

The image forming unit 12 is a component that forms a toner image on the recording medium P by an electrophotographic system. Specifically, as illustrated in FIG. 1, the image forming unit 12 includes toner image forming units 20 that form toner images, and a transfer apparatus 13 that transfers the toner images formed by the toner image forming units 20 to the recording medium P.

### Toner Image Forming Unit 20

A plurality of toner image forming units 20 illustrated in FIG. 1 are provided so as to form toner images for different colors. In the present exemplary embodiment, the toner image forming units 20 of four colors in total of yellow (Y), magenta (M), cyan (C), and black (K) are provided. (Y), (M), (C), and (K) illustrated in FIG. 1 indicate constituent parts corresponding to the respective colors described above.

Since the toner image forming units 20 of the respective colors have the same configuration except for the toners to be used, constituent parts of the toner image forming unit 20 (K) are denoted by reference numerals in FIG. 1 as a representative of the toner image forming units 20 of the respective colors.

Specifically, the toner image forming unit 20 of each color includes a photoreceptor 22 that rotates in one direction (for example, a counterclockwise direction in FIG. 1). The toner image forming unit 20 of each color includes a charger 23, an exposure apparatus 24, and a developing apparatus 25.

In the toner image forming unit 20 of each color, the charger 23 charges the photoreceptor 22. Further, the exposure apparatus 24 exposes the photoreceptor 22 charged by the charger 23 to form an electrostatic latent image on the photoreceptor 22. The developing apparatus 25 develops the electrostatic latent image formed on the photoreceptor 22 by the exposure apparatus 24 to form a toner image.

### Transfer Apparatus 13

The transfer apparatus 13 illustrated in FIG. 1 is an apparatus that transfers the toner images formed by the toner image forming units 20 to the recording medium P. Specifically, the transfer apparatus 13 primarily transfers the toner images on the photoreceptors 22 of the respective colors onto a transfer belt 30 serving as an intermediate transfer body in a superimposed manner, and secondarily transfers the superimposed toner images onto the recording medium P. As illustrated in FIG. 1, the transfer apparatus 13 includes the transfer belt 30, primary transfer rolls 32, and a transfer cylinder 40. The transfer cylinder 40 is an example of a transfer body.

The primary transfer rolls 32 are rolls that transfer the toner images on the photoreceptors 22 of the respective colors to the transfer belt 30 at primary transfer positions T1 between the photoreceptors 22 and the primary transfer rolls 32. In the present exemplary embodiment, a primary transfer electric field is applied between the primary transfer roll 32 and the photoreceptor 22, and thus the toner image formed on the photoreceptor 22 is transferred onto the transfer belt 30 at each of the primary transfer positions T1.

The toner images are transferred onto an outer circumferential surface of the transfer belt 30 from the photoreceptors 22 of the respective colors. As illustrated in FIG. 1, the transfer belt 30 has an endless shape, and is wound around a plurality of rolls 33 and an opposing roll 34 so as to have an inverted triangular posture in front view (as viewed in the apparatus depth direction). The transfer belt 30 circulates in a direction of an arrow A as at least one of the plurality of rolls 33 is rotationally driven.

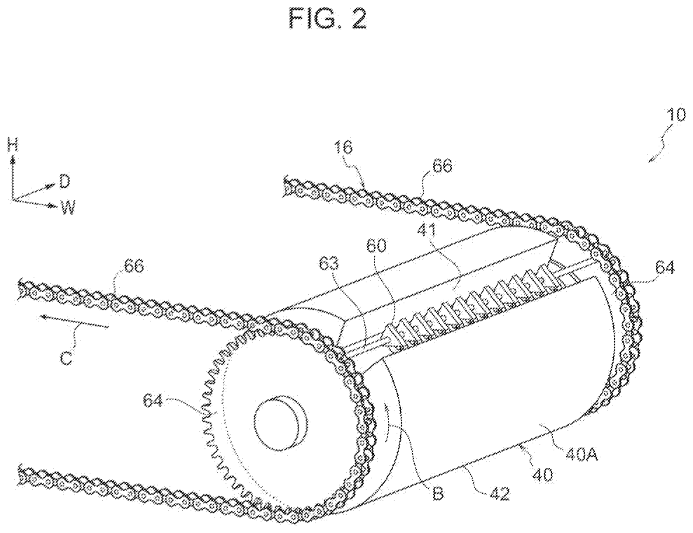

The transfer cylinder 40 has a function of transferring the transferred toner image on the transfer belt 30 onto the recording medium P. As illustrated in FIGS. 1 and 2, the transfer cylinder 40 (specifically, a cylinder main body 42 to be described later) has a concave portion 41 formed in an outer circumferential surface 40A thereof and rotates in a rotation direction B. The concave portion 41 is elongated along an axial direction of the transfer cylinder 40 and has a depth along a radial direction of the transfer cylinder 40.

As illustrated in FIG. 1, the transfer cylinder 40 is disposed below the transfer belt 30 so as to face the transfer belt 30. Further, the transfer cylinder 40 comes into contact with the transfer belt 30 in a range of the outer circumferential surface 40A from an upstream end to a downstream end of the concave portion 41 in the rotation direction.

As illustrated in FIG. 2, the transfer cylinder 40 includes a pair of sprockets 64 on both end sides in the axial direction. Specifically, the transfer cylinder 40 has the substantially cylindrical cylinder main body 42 and the pair of sprockets 64 provided on the both end sides of the cylinder main body 42 in the axial direction. The pair of sprockets 64 are disposed on the same axis as the cylinder main body 42.

Further, in the transfer cylinder 40, when the cylinder main body 42 is rotationally driven by a drive unit (not illustrated) to rotate in the rotation direction B, the cylinder main body 42 and the pair of sprockets 64 rotate integrally in the rotation direction B.

In the present exemplary embodiment, the transfer belt 30 and the transfer cylinder 40 (specifically, the cylinder main body 42) convey the recording medium P with the recording medium P sandwiched therebetween at a secondary transfer position T2 (see FIG. 1). Further, a secondary transfer electric field is applied between the opposing roll 34 and the transfer cylinder 40, and thus the transfer cylinder 40 transfers the transferred toner image on the transfer belt 30 onto the recording medium P at the secondary transfer position T2. Note that grippers 60 and attachment members 63 described later, that hold the recording medium P, are accommodated in the concave portion 41 when passing through the secondary transfer position T2, and contact with the transfer belt 30 is avoided.

### Fixing Apparatus 15

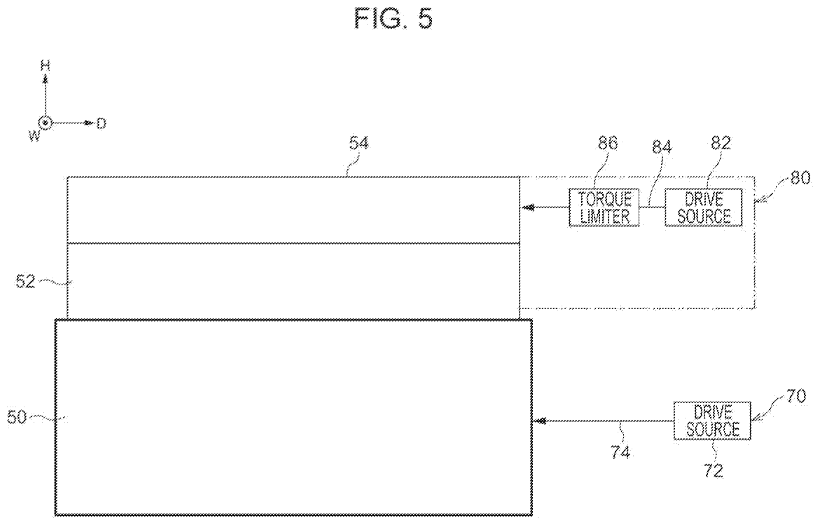

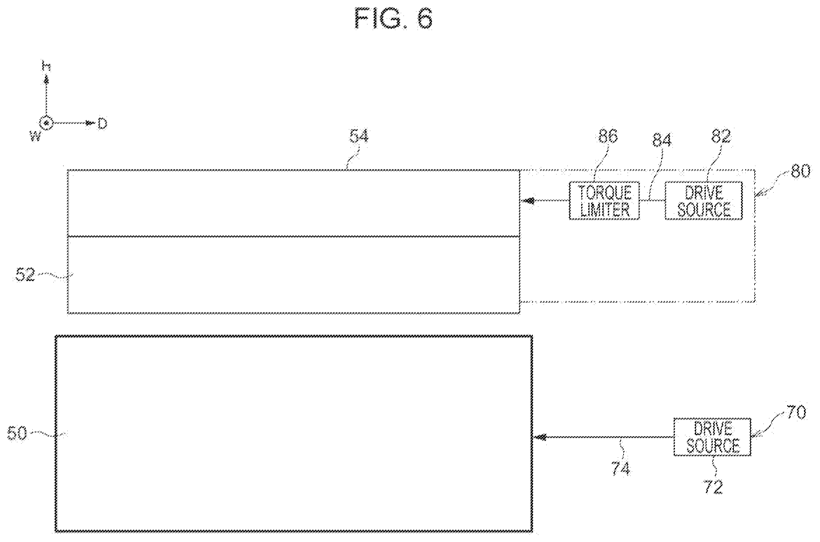

The fixing apparatus 15 is an example of a rotation apparatus, and is an apparatus that fixes the toner image transferred onto the recording medium P by the transfer cylinder 40 to the recording medium P. Specifically, as illustrated in FIG. 1, the fixing apparatus 15 includes a fixing cylinder 50, a heating roll 52, and a pair of external heating rolls 54. Furthermore, as illustrated in FIGS. 5 and 6, the fixing apparatus 15 includes a first drive mechanism 70 and a second drive mechanism 80. The fixing cylinder 50 is an example of a first rotating body and the heating roll 52 is an example of a second rotating body.

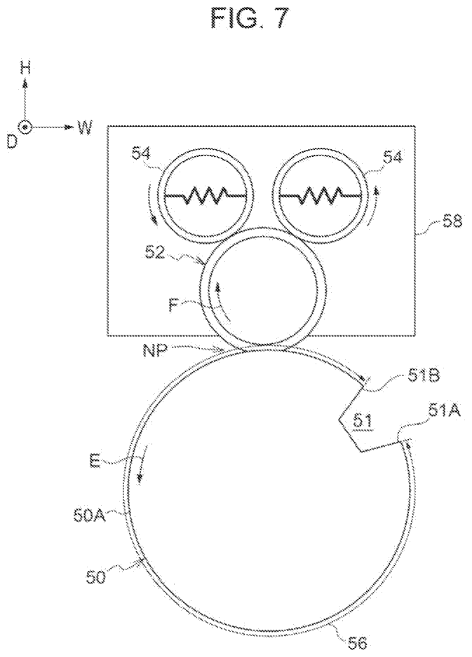

In the fixing apparatus 15, as illustrated in FIGS. 7, 8, and 9, the heating roll 52 is disposed above the fixing cylinder 50. The fixing cylinder 50 has a larger diameter and a larger mass (that is, moment of inertia) than the heating roll 52. The heating roll 52 is in contact with and heated by the pair of external heating rolls 54.

The fixing cylinder 50 is a rotating body that is rotatable in a rotation direction E. The fixing cylinder 50 (specifically, a cylinder main body 53 to be described later) has a concave portion 51 formed in an outer circumferential surface 50A thereof, and rotates in the rotation direction E by the first drive mechanism 70 (see FIGS. 5 and 6). The rotation direction E is an example of a predetermined rotation direction. The concave portion 51 is provided in a part of the outer circumferential surface of the fixing cylinder 50 in a circumferential direction. Further, the concave portion 51 is elongated along an axial direction of the fixing cylinder 50 and has a depth along a radial direction of the fixing cylinder 50. The grippers 60 and the attachment members 63, which will be described later, are accommodated in the concave portion 51. Thus, when the grippers 60 and the attachment members 63 pass through a fixing position NP, contact with the heating roll 52 is avoided.

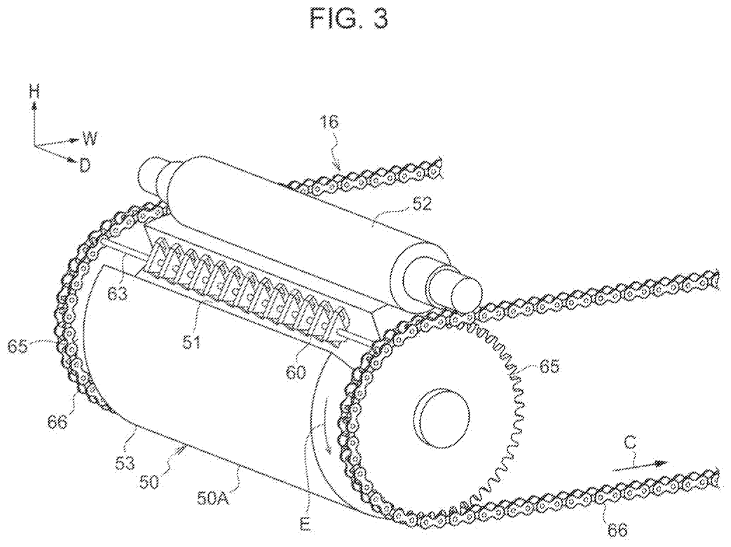

As illustrated in FIG. 3, the fixing cylinder 50 includes a pair of sprockets 65 on both end sides in an axial direction. Specifically, the fixing cylinder 50 includes the substantially cylindrical cylinder main body 53 and the sprockets 65 provided on the both end sides of the cylinder main body 53 in the axial direction. The pair of sprockets 65 are disposed on the same axis as the cylinder main body 53. Further, in the fixing cylinder 50, when the cylinder main body 53 is rotationally driven by the first drive mechanism 70 (see FIGS. 5 and 6) to rotate in the rotation direction E, the cylinder main body 53 and the pair of sprockets 65 rotate integrally in the rotation direction E.

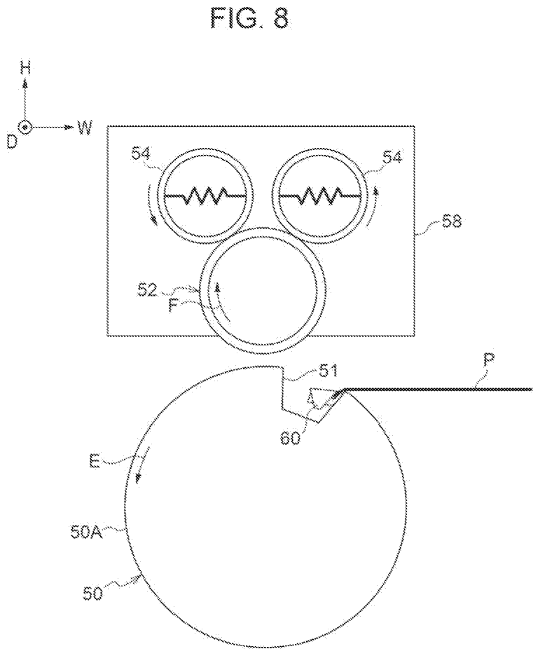

The heating roll 52 is a rotating body rotatable in a rotation direction F (a clockwise direction in FIG. 7) that is a reverse direction to the rotation direction E (a counterclockwise direction in FIG. 7). The heating roll 52 is movable to a contact position (a position illustrated in FIGS. 5 and 7) at which the heating roll 52 comes into contact with the outer circumferential surface of the fixing cylinder 50, and a separation position (a position illustrated in FIGS. 6 and 8) at which the heating roll 52 is separated from the fixing cylinder 50 outward in the radial direction of the fixing cylinder 50. In the present exemplary embodiment, the heating roll 52 rotates in a forward direction (the rotation direction F) with respect to the rotation of the fixing cylinder 50 at the contact position. The rotation direction F is an example of a reverse direction.

In the present exemplary embodiment, the heating roll 52 and the pair of external heating rolls 54 are supported by a support 58, and the heating roll 52 moves integrally with the pair of external heating rolls 54 to the contact position (a position illustrated in FIGS. 5 and 7) and the separation position (a position illustrated in FIGS. 6 and 8) by a moving mechanism using a cam or the like.

The moving mechanism positions the heating roll 52 at the contact position, at a rotation position at which a contact range 56 (see FIG. 7) in the fixing cylinder 50 faces the heating roll 52. At the contact position, the heating roll 52 and the fixing cylinder 50 are in contact with each other (hereinafter, referred to as a contact state). The contact range 56 (see FIG. 7) is a range of the outer circumferential surface 50A from an upstream end 51A to a downstream end 51B of the concave portion 51. Note that the contact range 56 (see FIG. 7) in the fixing cylinder 50 does not need to be in the contact state in an entire area of the rotation position at which the contact range 56 faces the heating roll 52.

The moving mechanism positions the heating roll 52 at the separation position, at a rotation position at which the concave portion 51 in the fixing cylinder 50 faces the heating roll 52. At the separation position, the heating roll 52 and the fixing cylinder 50 are separated from each other (hereinafter, referred to as a separated state). Note that the heating roll 52 and the fixing cylinder 50 do not need to be in the separated state in an entire area of the rotation position at which the concave portion 51 in the fixing cylinder 50 faces the heating roll 52.

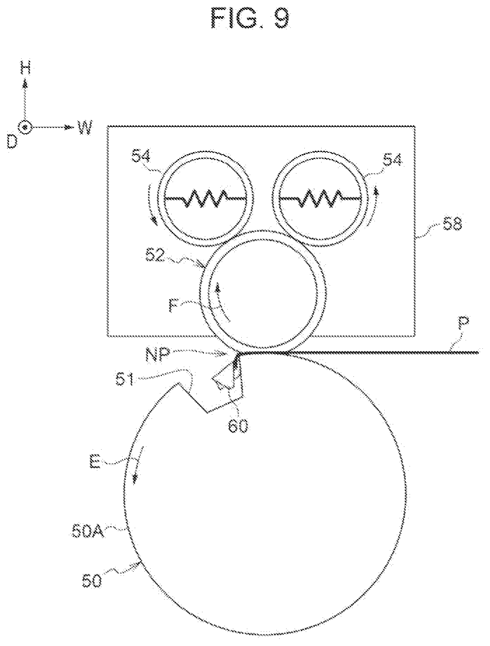

In the contact state, the heating roll 52 comes into contact with the contact range 56 and, as illustrated in FIG. 9, sandwiches the recording medium P with the fixing cylinder 50. Note that the heating roll 52 does not need to come into contact with the entire contact range 56, but may come into contact with at least a part of the contact range 56.

Further, in the fixing apparatus 15, the heating roll 52 heats the recording medium P and the heating roll 52 and the fixing cylinder 50 apply pressure to the recording medium P while the recording medium P is conveyed in a state of being sandwiched between the heating roll 52 and the fixing cylinder 50 at the fixing position NP, thereby fixing the transferred toner image on the recording medium P to the recording medium P. Note that the first drive mechanism 70 and the second drive mechanism 80 will be described later.

### Conveyance Mechanism 16

The conveyance mechanism 16 illustrated in FIG. 1 is a mechanism that conveys the recording medium P. As illustrated in FIGS. 1 and 2, the conveyance mechanism 16 has a pair of chains 66 and the grippers 60.

The chain 66 is an example of a circulating portion, and the gripper 60 is an example of a holding portion. In FIG. 1, one of the pair of chains 66 is illustrated, and the chains 66 and the grippers 60 are illustrated in a simplified manner.

As illustrated in FIG. 1, the pair of chains 66 are formed in an annular shape. As illustrated in FIG. 2, the pair of chains 66 are disposed at intervals in the apparatus depth direction (a D direction in the drawing). Each of the pair of chains 66 is wound around a respective one of the pair of sprockets 64 provided on the both end sides of the transfer cylinder 40 in the axial direction and a respective one of the pair of sprockets 65 (see FIG. 3) provided on the both end sides of the fixing cylinder 50 in the axial direction. Further, the transfer cylinder 40 is rotationally driven in the rotation direction B (the direction of an arrow B) and the fixing cylinder 50 is rotationally driven in the rotation direction E, and thus the chains 66 circulate in a circulation direction C (a direction of an arrow C).

As illustrated in FIG. 2, the attachment members 63 to which the grippers 60 are attached are stretched between the pair of chains 66 along the apparatus depth direction. A plurality of attachment members 63 are fixed to the pair of chains 66 at predetermined intervals along the circulation direction C of the chains 66.

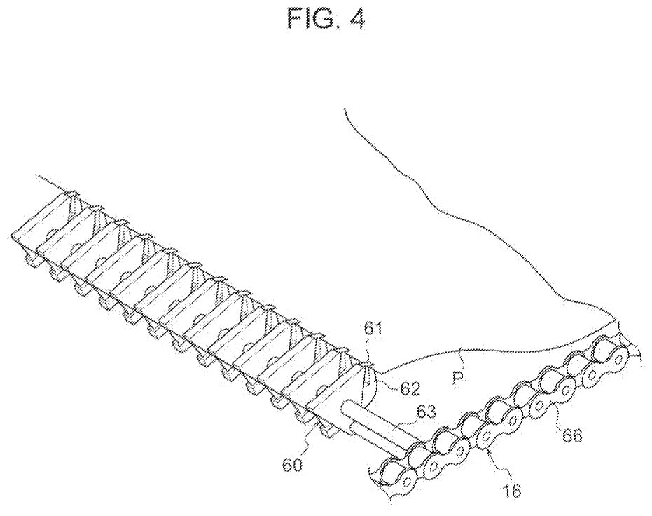

As illustrated in FIG. 2, the plurality of grippers 60 are attached to the attachment members 63 at predetermined intervals along the apparatus depth direction. The gripper 60 functions as a holding portion to hold a leading end portion of the recording medium P. Specifically, as illustrated in FIG. 4, the gripper 60 includes a claw 61 and a claw stand 62. The gripper 60 is configured to hold the recording medium P by sandwiching the leading end portion of the recording medium P between the claw 61 and the claw stand 62. Note that in the gripper 60, for example, the claw 61 is pressed against the claw stand 62 by a spring or the like, and the claw 61 is opened or closed with respect to the claw stand 62 by an operation of a cam or the like.

In the conveyance mechanism 16, as illustrated in FIG. 4, the leading end portion of the recording medium P fed from an accommodation unit (not illustrated) in which the recording medium P is accommodated is held by the gripper 60. The gripper 60 holding the leading end portion of the recording medium P conveys the recording medium P and causes the recording medium P to pass through the secondary transfer position T2 by the circulation of the chains 66 in the circulation direction C. Further, at the secondary transfer position T2, the transfer cylinder 40 secondarily transfers the toner images, which are superimposed and primarily transferred onto the transfer belt 30 at the primary transfer positions T1 for the respective colors, onto the recording medium P at the secondary transfer position T2.

Further, as the chains 66 circulate in the circulation direction C, the grippers 60 holding the leading end portion of the recording medium P convey the recording medium P and cause the recording medium P to pass through the fixing position NP. Then, in the fixing apparatus 15, at the fixing position NP, the heating roll 52 sandwiches the recording medium P with the fixing cylinder 50 to fix the image on the recording medium P to the recording medium P.

Note that the grippers 60 are accommodated together with the attachment members 63 in the concave portion 41 formed on the outer circumferential surface of the transfer cylinder 40 when passing through the secondary transfer position T2, and are accommodated together with the attachment members 63 in the concave portion 51 formed on the outer circumferential surface of the fixing cylinder 50 when passing through the fixing position NP.

### First Drive Mechanism 70 and Second Drive Mechanism 80

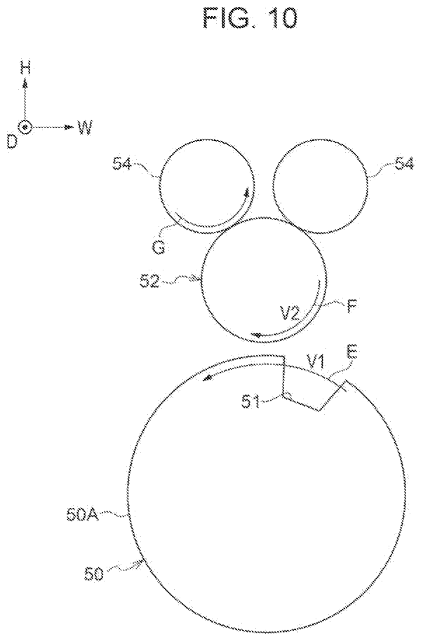

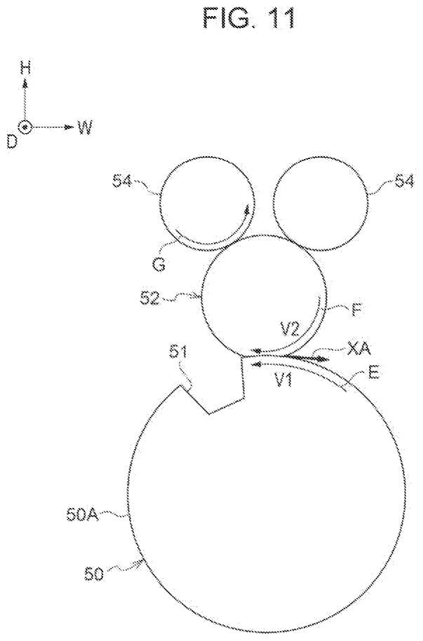

As illustrated in FIGS. 10 and 11, the first drive mechanism 70 illustrated in FIGS. 5 and 6 is a mechanism that rotationally drives the fixing cylinder 50 in the rotation direction E at a first circumferential speed (V1) and subordinately rotates the heating roll 52 at the contact position (a position illustrated in FIG. 11) of the heating roll 52. As illustrated in FIGS. 5 and 6, the first drive mechanism 70 includes a drive source 72 including a drive motor and the like, and a transmission unit 74 that transmits a driving force of the drive source 72 to the fixing cylinder 50. The transmission unit 74 includes mechanical elements such as a gear, a coupling, a belt, and a pulley, for example.

The second drive mechanism 80 illustrated in FIGS. 5 and 6 is a mechanism that generates a driving force in the rotation direction F with respect to the heating roll 52 at the contact position (a position illustrated in FIG. 11) of the heating roll 52 and the separation position (a position illustrated in FIG. 10) of the heating roll 52.

The second drive mechanism 80 rotationally drives the heating roll 52 at a second circumferential speed (V2) lower than the first circumferential speed (V1) of the fixing cylinder 50 at the separation position (the position illustrated in FIG. 10) of the heating roll 52. Furthermore, the second drive mechanism 80 applies a resistance force (see an arrow XA) in a reverse direction to the rotation direction E with respect to the fixing cylinder 50 via the heating roll 52 at the contact position (the position illustrated in FIG. 11) of the heating roll 52.

Specifically, as illustrated in FIGS. 5 and 6, the second drive mechanism 80 includes a drive source 82 including a drive motor or the like, and a transmission unit 84 that transmits a driving force of the drive source 82 to the heating roll 52. The transmission unit 84 includes, for example, mechanical elements such as a gear, a coupling, a belt, and a pulley, and the pair of external heating rolls 54. The pair of external heating rolls 54 are an example of a third rotating body.

In the present exemplary embodiment, in a state in which the pair of external heating rolls 54 are in contact with the heating roll 52, the second drive mechanism 80 rotationally drives at least one of the pair of external heating rolls 54 in a rotation direction G, thereby subordinately rotating the heating roll 52. The pair of external heating rolls 54 move integrally with the heating roll 52 that performs contact and separation with respect to the fixing cylinder 50 while maintaining the state of being in contact with the heating roll 52. In the present exemplary embodiment, the pair of external heating rolls 54 that subordinately rotate the heating roll 52 heat the heating roll 52.

Furthermore, as illustrated in FIGS. 5 and 6, the second drive mechanism 80 includes a torque limiter 86 that limits the driving force transmitted from the drive source 82 to the heating roll 52. The torque limiter 86 is disposed in a transmission path of the transmission unit 84.

The torque limiter 86 cuts off the transmission of the driving force of the drive source 82 to the heating roll 52 when load torque from the fixing cylinder 50 to the heating roll 52 becomes predetermined torque or more at the contact position of the heating roll 52. As a result, the heating roll 52 rotates as the fixing cylinder 50 rotates. At this time, a resistance force (see the arrow XA) in the reverse direction to the rotation direction E from the heating roll 52 is applied to the fixing cylinder 50.

As described above, the torque limiter 86 functions as a limiting unit that limits the driving force transmitted from the drive source 82 to the heating roll 52. Note that a one-way clutch may be used as the limiting unit instead of the torque limiter 86.

The second drive mechanism 80 is supported by the support 58 together with the heating roll 52 and the pair of external heating rolls 54, and moves between the contact position (the position illustrated in FIG. 5) and the separation position (the position illustrated in FIG. 6) together with the heating roll 52 and the pair of external heating rolls 54.

### Operation of Present Exemplary Embodiment

In the present exemplary embodiment, as described above, the second drive mechanism 80 applies a resistance force (see the arrow XA) in the reverse direction to the rotation direction E to the fixing cylinder 50 via the heating roll 52 at the contact position (the position illustrated in FIG. 11) of the heating roll 52.

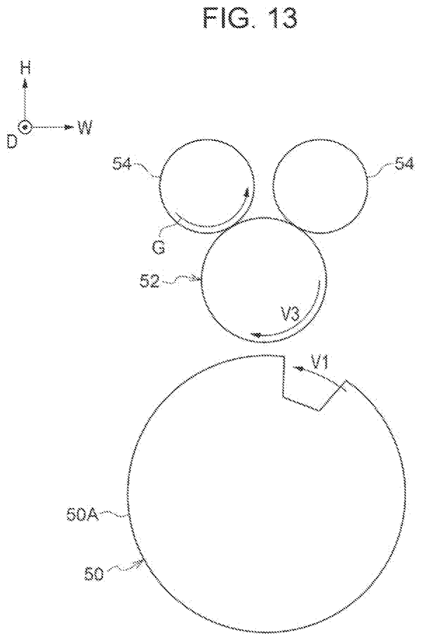

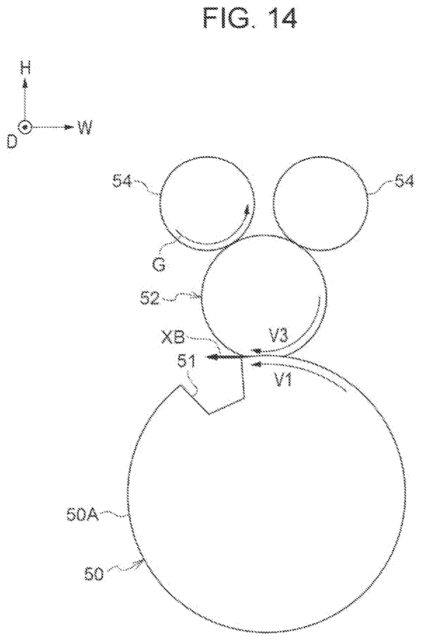

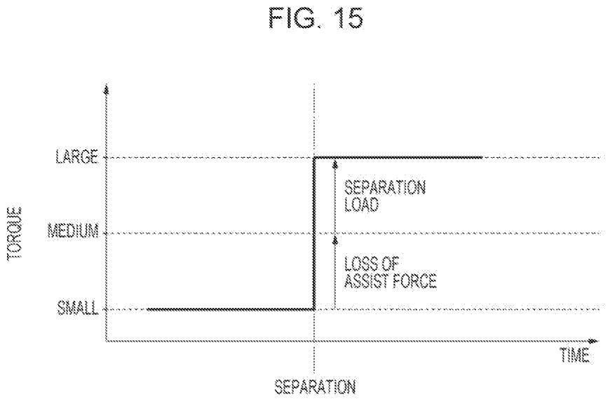

Here, as illustrated in FIG. 14, when the second drive mechanism 80 applies a rotating force (see an arrow XB) in the rotation direction E to the fixing cylinder 50 via the heating roll 52 at the contact position of the heating roll 52 (hereinafter, referred to as a circumstance A), as illustrated in FIG. 15, torque (that is, a rotational load) generated in the fixing cylinder 50 fluctuates when the heating roll 52 moves from the contact position (a position illustrated in FIG. 14) to the separation position (a position illustrated in FIG. 13). Note that in the circumstance A, for example, the second drive mechanism 80 rotationally drives the heating roll 52 at a third circumferential speed (V3) higher than the first circumferential speed (V1) of the fixing cylinder 50 at the separation position (the position illustrated in FIG. 13) of the heating roll 52. In the circumstance A, since the rotating force (see the arrow XB) in the rotation direction E is applied to the fixing cylinder 50 at the contact position of the heating roll 52, the rotating force acts as an assist force to assist the rotation of the fixing cylinder 50, resulting in a state in which the torque generated in the fixing cylinder 50 is reduced. Therefore, as illustrated in FIG. 15, the torque generated in the fixing cylinder 50 becomes a “small” state.

Further, in the circumstance A, when the heating roll 52 moves from the contact position to the separation position, the assist force is lost, and a load (hereinafter, referred to as separation load) is generated in the fixing cylinder 50 with the separation of the heating roll 52 from the fixing cylinder 50. Thus, as illustrated in FIG. 15, the torque generated in the fixing cylinder 50 becomes a “large” state, so that the torque (that is, a rotational load) generated in the fixing cylinder 50 fluctuates. Note that the separation load is generated, for example, by kicking out the fixing cylinder 50 when the heating roll 52 separates from the fixing cylinder 50.

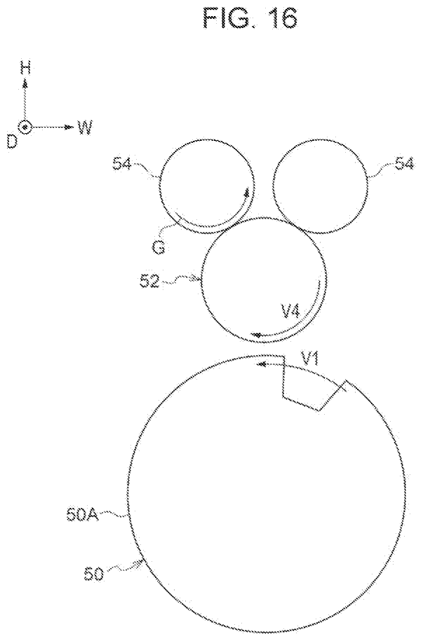

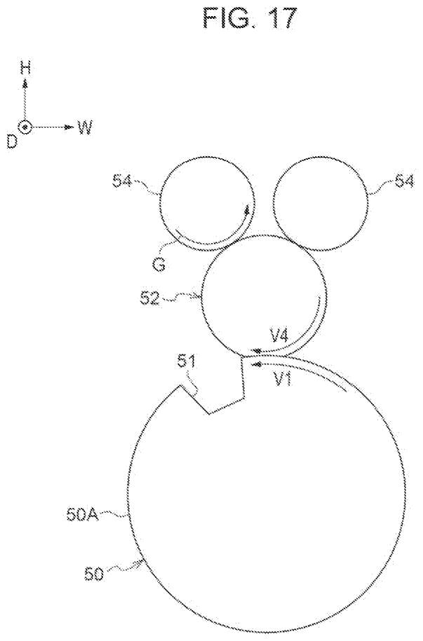

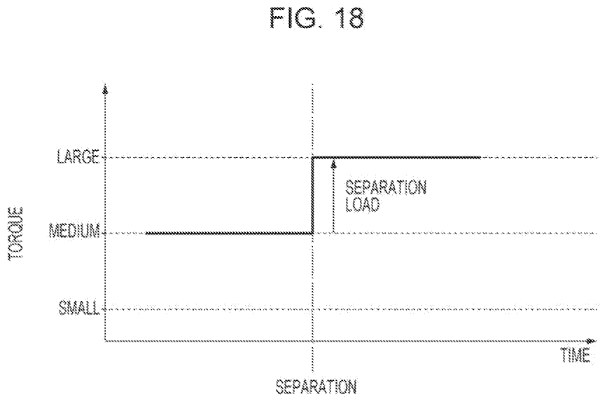

Furthermore, even in a case where the second drive mechanism 80 applies neither the rotating force (see the arrow XB in FIG. 14) in the rotation direction E nor the resistance force (see the arrow XA in FIG. 11) in the reverse direction to the rotation direction E to the fixing cylinder 50 via the heating roll 52 at the contact position of the heating roll 52 as illustrated in FIG. 17 (hereinafter, referred to as a circumstance B), torque (that is, the rotational load) generated in the fixing cylinder 50 fluctuates when the heating roll 52 moves from the contact position (a position illustrated in FIG. 17) to the separation position (a position illustrated in FIG. 16) as illustrated in FIG. 18. Note that in the circumstance B, for example, the second drive mechanism 80 rotationally drives the heating roll 52 at a fourth circumferential speed (V4) that is the same as the first circumferential speed (V1) of the fixing cylinder 50 at the separation position (the position illustrated in FIG. 16) of the heating roll 52.

In the circumstance B, unlike the circumstance A, even when the heating roll 52 moves from the contact position to the separation position, the assist force is not lost, but since the separation load is generated due to the separation of the heating roll 52 from the fixing cylinder 50, as illustrated in FIG. 18, the torque generated in the fixing cylinder 50 changes from “medium” to “large”, and the torque (that is, the rotational load) generated in the fixing cylinder 50 fluctuates.

As in the circumstance A and the circumstance B, when the torque (that is, the rotational load) generated in the fixing cylinder 50 fluctuates, vibration due to the fluctuation is propagated to the transfer belt 30 via the chains 66 and the transfer cylinder 40, and transfer failure or image disturbance in the toner image forming unit 20 may occur.

On the other hand, in the present exemplary embodiment, since the resistance force (see the arrow XA) in the reverse direction to the rotation direction E is applied to the fixing cylinder 50 at the contact position of the heating roll 52, when the heating roll 52 moves from the contact position to the separation position, the resistance force is lost and the separation load due to the separation of the heating roll 52 from the fixing cylinder 50 is generated.

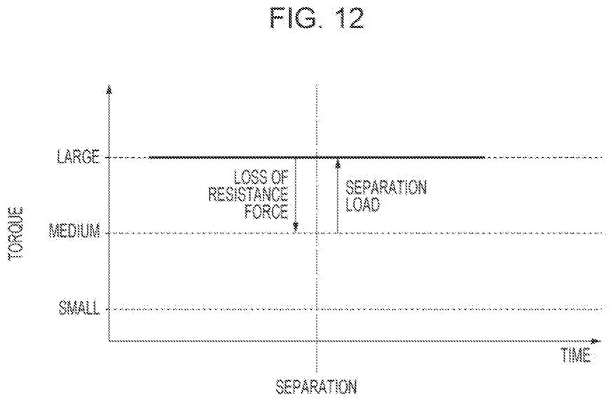

Thus, an amount of decrease in torque due to the loss of the resistance force and an amount of increase in torque due to the occurrence of the separation load cancel each other out, and as illustrated in FIG. 12, the fluctuation in torque generated in the fixing cylinder 50 when the heating roll 52 moves from the contact position to the separation position is suppressed compared to the circumstance A and the circumstance B.

In this way, since the fluctuation in the torque generated in the fixing cylinder 50 is suppressed, the vibration of the fixing apparatus 15 due to the fluctuation is suppressed. Further, the vibration due to the fluctuation is hardly propagated to the transfer belt 30 via the chains 66 and the transfer cylinder 40, and the transfer failure and the image disturbance in the toner image forming unit 20 are suppressed.

In addition, in the present exemplary embodiment, the pair of external heating rolls 54 rotate in a state of being in contact with the heating roll 52, and thus the heating roll 52 is subordinately rotated.

Therefore, a mechanism for inputting a driving force to a rotation shaft of the heating roll 52 is unnecessary, thereby simplifying the configuration around the rotation shaft of the heating roll 52 as compared with the case where the second drive mechanism 80 directly and rotationally drives the heating roll 52.

Furthermore, in the present exemplary embodiment, as described above, the pair of external heating rolls 54 move integrally with the heating roll 52 that performs contact and separation with respect to the fixing cylinder 50 while maintaining the state of being in contact with the heating roll 52.

Therefore, a fluctuation in the rotation speed of the heating roll 52 is suppressed as compared with the case where the pair of external heating rolls 54 are separated from the heating roll 52 that performs contact and separation.

In addition, in the present exemplary embodiment, the pair of external heating rolls 54 that subordinately rotate the heating roll 52 heat the heating roll 52.

Therefore, the number of parts is reduced as compared with the case where the heating roll 52 is heated by heating means different from a roll for subordinately rotating the heating roll 52.

Furthermore, in the present exemplary embodiment, the heating roll 52 is positioned at the separation position, at the rotation position of the fixing cylinder 50, facing the concave portion 51 of the fixing cylinder 50.

For this reason, compared to the case where the heating roll 52 is positioned at the separation position only at the rotation position of the fixing cylinder 50 at which the portion other than the concave portion 51 in the outer circumferential surface 50A of the fixing cylinder 50 faces, vibration of the heating roll 52 due to a step of the concave portion 51 and collision with the grippers 60 accommodated in the concave portion 51 are suppressed.

### Modification of Second Drive Mechanism 80

In the present exemplary embodiment, as described above, the second drive mechanism 80 applies a resistance force (see the arrow XA) in the reverse direction to the rotation direction E to the fixing cylinder 50 via the heating roll 52 at the contact position (the position illustrated in FIG. 11) of the heating roll 52, but it is not necessary to constantly apply the resistance force at the contact position of the heating roll 52.

For example, after the second drive mechanism 80 applies a rotating force in the rotation direction E to the fixing cylinder 50 via the heating roll 52 at the contact position (the position illustrated in FIG. 11) of the heating roll 52 (see FIG. 14), the second drive mechanism 80 may apply a resistance force (see the arrow XA) in the reverse direction to the fixing cylinder 50 via the heating roll 52 before the heating roll 52 moves to the separation position (see FIG. 11).

According to this configuration, compared to the case where the second drive mechanism 80 constantly applies a resistance force in the reverse direction to the fixing cylinder 50 via the heating roll 52 at the contact position (the position illustrated in FIG. 11) of the heating roll 52, the torque generated in the fixing cylinder 50 is reduced in a state in which the heating roll 52 is positioned at the contact position.

Furthermore, in the present exemplary embodiment, as described above, the second drive mechanism 80 rotationally drives the heating roll 52 at the second circumferential speed (V2) that is lower than the first circumferential speed (V1) of the fixing cylinder 50 at the separation position (the position illustrated in FIG. 10) of the heating roll 52, but it is not necessary that the second drive mechanism 80 constantly and rotationally drives the heating roll 52 at the second circumferential speed (V2) at the separation position of the heating roll 52.

For example, after the second drive mechanism 80 rotationally drives the heating roll 52 at the second circumferential speed (V2) at the separation position of the heating roll 52, the second drive mechanism 80 may rotationally drive the heating roll 52 at the third circumferential speed (V3) higher than the first circumferential speed (V1) before the heating roll 52 moves to the contact position (see FIG. 13).

According to this configuration, the torque generated in the fixing cylinder 50 when the heating roll 52 moves from the separation position to the contact position is smaller than that in the case where the second drive mechanism 80 constantly and rotationally drives the heating roll 52 at the second circumferential speed (V2) at the separation position of the heating roll 52.

### Modification of First Rotating Body, Second Rotating Body, and Third Rotating Body

Although the fixing cylinder 50 is used as an example of the first rotating body in the present exemplary embodiment, the first rotating body is not limited thereto. An example of the first rotating body may be the transfer cylinder 40, a transfer roll, a conveyance roll, or the like.

Furthermore, although the heating roll 52 is used as an example of the second rotating body in the present exemplary embodiment, the second rotating body is not limited thereto. An example of the second rotating body may be, for example, a transfer roll, a conveyance roll, or the like.

In the present exemplary embodiment, the pair of external heating rolls 54 are used as an example of the third rotating body, but the third rotating body is not limited thereto. An example of the third rotating body may be, for example, a roll or the like that does not involve heating.

### Other Modifications

In the present exemplary embodiment, the pair of external heating rolls 54 rotate in contact with the heating roll 52 to subordinately rotate the heating roll 52, but the configuration is not limited thereto. For example, a configuration may be adopted in which the second drive mechanism 80 directly and rotationally drives the heating roll 52.

In addition, in the present exemplary embodiment, as described above, the pair of external heating rolls 54 move integrally with the heating roll 52 that performs contact and separation with respect to the fixing cylinder 50 while maintaining a state of being in contact with the heating roll 52, but the configuration is not limited thereto. A configuration may be adopted in which the pair of external heating rolls 54 are separated from the heating roll 52 that performs contact and separation.

In addition, in the present exemplary embodiment, the pair of external heating rolls 54 that subordinately rotate the heating roll 52 heat the heating roll 52, but the configuration is not limited thereto. For example, a configuration may be adopted in which heating means different from a roll that subordinately rotates the heating roll 52 heats the heating roll 52.

In addition, in the present exemplary embodiment, the grippers 60 and the attachment members 63 are accommodated in the concave portion 51 of the fixing cylinder 50, but the configuration is not limited thereto. The concave portion 51 may be provided for any other purpose.

The present disclosure is not limited to the above-described exemplary embodiment, and various modifications, changes, and improvements can be made without departing from the spirit of the present disclosure. For example, the modifications described above may be configured by combining a plurality of modifications as appropriate.

### Appendix

(((1)))

A rotation apparatus comprising:
a first rotating body rotatable in a predetermined rotation direction;
a second rotating body movable to a contact position at which the second rotating body comes into contact with an outer circumferential surface of the first rotating body and a separation position at which the second rotating body is separated from the first rotating body outward in a radial direction of the first rotating body and rotatable in a reverse direction to the rotation direction;
a first drive mechanism that rotationally drives the first rotating body at a first circumferential speed and subordinately rotates the second rotating body at the contact position; and
a second drive mechanism that generates a driving force in the reverse direction with respect to the second rotating body at the contact position and the separation position, rotationally drives the second rotating body at a second circumferential speed lower than the first circumferential speed at the separation position, and applies a resistance force in the reverse direction to the first rotating body via the second rotating body at the contact position.
   (((2)))

The rotation apparatus according to (((1))), wherein the second drive mechanism includes a third rotating body that rotates in a contact state with the second rotating body to subordinately rotate the second rotating body.

(((3)))

The rotation apparatus according to (((2))), wherein the third rotating body moves integrally with the second rotating body while remaining a contact state with the second rotating body that moves between the contact position and the separation position.

(((4)))

The rotation apparatus according to (((2))) or (((3))), wherein the third rotating body heats the second rotating body.

(((5)))

The rotation apparatus according to any one of (((1)))), wherein after the second drive mechanism applies a rotating force in the rotation direction to the first rotating body via the second rotating body at the contact position, the second drive mechanism applies a resistance force in the reverse direction to the first rotating body via the second rotating body before the second rotating body moves to the separation position.

(((6)))

The rotation apparatus according to (((5))), wherein after the second drive mechanism rotationally drives the second rotating body at the second circumferential speed at the separation position, the second drive mechanism rotationally drives the second rotating body at a third circumferential speed higher than the first circumferential speed before the second rotating body moves to the contact position.

(((7)))

The rotation apparatus according to any one of (((1)) to ((6))), wherein a concave portion is formed on the outer circumferential surface of the first rotating body, and the second rotating body is positioned at the separation position at a rotation position of the first rotating body, facing the concave portion.

(((8)))

A fixing apparatus as the rotation apparatus according to (((7))), wherein the first rotating body and the second rotating body sandwich a recording medium to fix an image on the recording medium onto the recording medium.

(((9)))

An image forming apparatus comprising:
a circulating portion to which a holding portion to hold a recording medium is attached and that is wound around the first rotating body and circulates by rotation of the first rotating body to convey the recording medium;
a transfer body which the circulating portion is wound around and that transfers an image to a recording medium conveyed by the circulating portion; and
the fixing apparatus according to (((8))) that fixes the image transferred by the transfer body to the recording medium.

What is claimed is:

1. A rotation apparatus comprising:
a first rotating body rotatable in a predetermined rotation direction;
a second rotating body movable to a contact position at which the second rotating body comes into contact with an outer circumferential surface of the first rotating body and a separation position at which the second rotating body is separated from the first rotating body outward in a radial direction of the first rotating body and rotatable in a reverse direction to the rotation direction;
a first drive mechanism that rotationally drives the first rotating body at a first circumferential speed and subordinately rotates the second rotating body at the contact position; and
a second drive mechanism that generates a driving force in the reverse direction with respect to the second rotating body at the contact position and the separation position, rotationally drives the second rotating body at a second circumferential speed lower than the first circumferential speed at the separation position, and applies a resistance force in the reverse direction to the first rotating body via the second rotating body at the contact position.

2. The rotation apparatus according to claim 1, wherein
the second drive mechanism includes a third rotating body that rotates in a contact state with the second rotating body to subordinately rotate the second rotating body.

3. The rotation apparatus according to claim 2, wherein
the third rotating body moves integrally with the second rotating body while remaining a contact state with the second rotating body that moves between the contact position and the separation position.

4. The rotation apparatus according to claim 2, wherein
the third rotating body heats the second rotating body.

5. The rotation apparatus according to claim 1, wherein
after the second drive mechanism applies a rotating force in the rotation direction to the first rotating body via the second rotating body at the contact position, the second drive mechanism applies a resistance force in the reverse direction to the first rotating body via the second rotating body before the second rotating body moves to the separation position.

6. The rotation apparatus according to claim 5, wherein
after the second drive mechanism rotationally drives the second rotating body at the second circumferential speed at the separation position, the second drive mechanism rotationally drives the second rotating body at a third circumferential speed higher than the first circumferential speed before the second rotating body moves to the contact position.

7. The rotation apparatus according to claim 1, wherein
a concave portion is formed on the outer circumferential surface of the first rotating body, and the second rotating body is positioned at the separation position at a rotation position of the first rotating body, facing the concave portion.

8. A fixing apparatus as the rotation apparatus according to claim 7, wherein
the first rotating body and the second rotating body sandwich a recording medium to fix an image on the recording medium onto the recording medium.

9. An image forming apparatus comprising:
a circulating portion to which a holding portion to hold a recording medium is attached and that is wound around the first rotating body and circulates by rotation of the first rotating body to convey the recording medium;
a transfer body which the circulating portion is wound around and that transfers an image to a recording medium conveyed by the circulating portion; and
the fixing apparatus according to claim 8 that fixes the image transferred by the transfer body to the recording medium.
